(19) United States
(12) Patent Application Publication
(10) Pub. No.: US 2013/0097196 A1
(43) Pub. Date: Apr. 18, 2013

(54) DATA MANAGEMENT DEVICE AND DATA MANAGEMENT METHOD

(71) Applicants: Masaru Fuse, Osaka (JP); Takamitsu Sasaki, Osaka (JP)

(72) Inventors: Masaru Fuse, Osaka (JP); Takamitsu Sasaki, Osaka (JP)

(21) Appl. No.: 13/805,220

(22) PCT Filed: Jun. 20, 2011
(86) PCT No.: PCT/JP2011/003511

§ 371 Date: Dec. 18, 2012

(30) Foreign Application Priority Data
Jun. 23, 2010 (JP) 2010 143203

(51) Int. Cl. G06F 17/30

(52) U.S. Cl. CPC G06F 17/30244
USPC 707/758

(57) ABSTRACT

A data management device for centrally storing electronic data acquired from a data processing device, the data management device comprising: an identification write unit for writing first identification indicating that the electronic data is saved in a storage device into the electronic data saved in the storage device, and outputting the electronic data having the written first identification to the data processing device; an identification detection unit for detecting second identification written in electronic data inputted from the data processing device, and determining whether the first identification and the second identification match; and a selection unit for recording, into the storage device, the electronic data inputted from the data processing device when it is determined that the first identification and the second identification do not match or when the second identification is not detected.

### TECHNICAL FIELD

The present invention relates to a data management device for centrally storing electronic data acquired from a data processing device, and a data management method.

### BACKGROUND ART

Utilizing digital AV (Audio Visual) equipment such as digital cameras, digital content data (hereinafter, simply referred to as “content”) such as a still image and a video can readily be created. Furthermore, such content can easily be carried by a user or exchanged among users by transferring the content to other device via a communication interface such as USB (Universal Serial Bus) and Ethernet (registered trademark), or various memory cards. Moreover, data processing such as duplication, editing, and modification can be performed on the content at a consumer level by a personal computer (PC) or the like. To fully exploit the vast number of content created in such a manner while storing the content, it is necessary to consolidate the content efficiently and easily.

Specifically, in order to avoid user confusion as to data management and utilize resources (capacity and the like) of a storage device without waste, it is required, for example, to accurately determine similar content and determine whether content is to be recorded, while avoiding redundancy of the same content. Thus, a technique is disclosed which determines, utilizing identification provided to image data, whether the image data is to be saved (for example, see PTL 1).

In the technique disclosed in PTL 1, identification is provided to image data in a digital camera or the like when generating the image data. Then, before the image data is to be recoded into a hard disk device, PC, or the like, the identification of the image data is compared with identification of image data previously saved in the hard disk device, PC, or the like. Then, based on a result of the comparison, it is determined whether the image data is existing data or new data to determine whether the image data is to be saved or discarded.

FIG. 13 is a block diagram showing a configuration of a conventional data management system disclosed in PTL 1. As shown in FIG. 13, the conventional data management system includes a data management device 9001 and a data processing device 9002. It should be noted that, in FIG. 13, the data management device 9001 corresponds to an image data recording device that includes a hard disk and so on, and the data processing device 9002 corresponds to an image data generating device such as a digital camera.

The data management device 9001 includes a main storage unit 901, a first output interface (I/F) unit 904, a first input I/F unit 910, an identification detection unit 911, and a determination/selection unit 912.

The data processing device 9002 generates/records/modifies image data to be managed by the data management device 9001. The data processing device 9002 includes an identification write unit 903, a second input I/F unit 905, a temporary storage unit 906, a second output I/F unit 907, and a data generation unit 908.

Operation of the data management system arranged as set forth above will be described.

First, in the data processing device 9002, the data generation unit 908 generates image data, using an imaging element or the like. The identification write unit 903 provides to the image data generated by the data generation unit 908 identification (ID) having uniqueness for identifying the image data, and creates an image file.

The image file is recorded or saved into the temporary storage unit 906. In a state in which the data processing device 9002 and the data management device 9001 are physically or logically in connection, the second output I/F unit 907 reads all or a portion of image files recorded in the temporary storage unit 906 and outputs the read all or portion of image files to the data management device 9001.

In the data management device 9001, the first input I/F unit 910 receives the image files outputted from the second output I/F unit 907 and outputs the image files to the identification detection unit 911.

The identification detection unit 911 extracts identification from each of the image files outputted from the first input I/F unit 910. The determination/selection unit 912 compares the identification extracted by the identification detection unit 911 with identification of an image file group saved in the main storage unit 901. Here, if an image file having the same identification is saved in the main storage unit 901, the determination/selection unit 912 discards the image file from which the identification has been extracted by the identification detection unit 911. On the other hand, if the image file having the same identification is not saved in the main storage unit 901, the determination/selection unit 912 records into the main storage unit 901 the image file from which the identification has been extracted by the identification detection unit 911.

In the state in which the data management device 9001 and the data processing device 9002 are physically or logically in connection, the first output I/F unit 904 reads all or a portion of image files saved in the main storage unit 901, and outputs the read all or portion of image files to the data processing device 9002.

In the data processing device 9002, the second input I/F unit 905 receives the image files outputted from the first output I/F unit 904 and outputs the image files to the temporary storage unit 906. The image files outputted from the second input I/F unit 905 are recorded into the temporary storage unit 906.

It should be noted that the data processing device that outputs the image files to the data management device (the first input I/F unit) and the data processing device that receives the image files from the data management device (the first output I/F unit) may not necessarily be the same individual and may be different individuals.

A digital camera, digital movie, or a client device such as mobile phones is assumed as representative of the data processing device. Moreover, a server device such as a PC or a recording device such as a hard disk is assumed as representative of the data management device. Moreover, for example, existing general purpose information such as a file name, a file size, creation date, and location information (GPS), or specific information set or recorded at a predetermined position of the image file for indicating the type or individual of the data processing device is assumed as the identification.

As described above, in the conventional data management system, the data processing device previously provides uniquely corresponding identification to created image data. The data management device then compares the identification of inputted image data with identification of image data previously saved in the data management device to determine the identity/non-identity of the inputted image data. As a result, the data management device can readily and efficiently determine whether the inputted image data is to be saved into a main storage unit or discarded, using a relatively small processing load, without handling the body (image information) of image data.

### CITATION LIST

### Patent Literature

[PTL 1] Japanese Patent No. 4409318

### SUMMARY OF INVENTION

### Technical Problem

However, in the conventional data management system as described above, the uniqueness between the body of image data and the identification, in fact, cannot necessarily be assured. For example, if a plurality of the data processing devices exists, the identification of the image data having different bodies may be the same. Moreover, in environment where rewrite of identification is allowed, image data having different identification may have the same body.

Specifically, in many cases, sequence numbers (0001, 0002, and so on) starting from “0000” in a format such as “IMG-00**.jpg” are provided as file names to image data by each digital camera. Thus, when image data captured by a plurality of cameras is centrally stored, it is often a case in which the image data having different bodies has the same file name.

Moreover, in general, a file name is easily modifiable by a PC or the like, and thus a situation also easily results in which different file names are used for the same content. Furthermore, once image data is modified, edited, or the like, using image processing software or the like, correspondence between the identification provided as file information and the body of the image data is increasingly fuzzy.

As described above, the conventional data management system has a problem that if the body of image data and identification is not in one-to-one correspondence, it is difficult to efficiently manage or save image data without redundancy and omission of image data.

As a remedy for this, a method is readily envisioned in which the data processing device newly provides advanced or specific identification whereby the uniqueness in the image data is assured. In this case, however, there arises a new problem that the processing load of the data processing device increases and additional cost is incurred. Furthermore, a traditional data processing device that has not implemented the functionality cannot support such a method, and thus area of application in system is limited. Therefore, a new problem is caused that the flexibility of the system is significantly hindered.

Thus, objects of the present invention is to overcome above problems and provide a data management device and data management method which can reduce processing load increase in the data processing device, covering any data processing devices including those of traditional models, and enhance the accuracy in determining the novelty of electronic data (whether the electronic data is unsaved), to store the electronic data without redundancy and omission of electronic data.

### Solution to Problem

To solve the above problems, a data management device according to one aspect of the present invention is a data management device for centrally storing electronic data acquired from a data processing device, the data management device including: an identification write unit configured to write first identification indicating that the electronic data is saved in a storage device into the electronic data saved in the storage device, and output the electronic data having the written first identification to the data processing device; an identification detection unit configured to detect second identification written in electronic data inputted from the data processing device, and determine whether the first identification and the second identification match; and a selection unit configured to record, into the storage device, the electronic data inputted from the data processing device when it is determined that the first identification and the second identification do not match or when the second identification is not detected.

According to the above configuration, since the data management device can write the identification into the electronic data, a processing load increase in the data processing device can be reduced. Moreover, when the first identification and the second identification detected in the electronic data inputted from the data processing device do not match, the electronic data is recorded into the storage device, thereby storing the image data without requiring the data processing device for special processing, and without redundancy and omission of image data.

Moreover, the identification detection unit may be configured to determine whether the first identification and the second identification match, based on a similarity indicative of a degree of similarity between the first identification and the second identification.

According to the above configuration, it can be determined, based on the similarity between the first identification and the second identification, whether the electronic data is to be recorded into the storage device. Thus, it can be determined whether the electronic data is to be recorded into the storage device, in accordance with the extent of modification of the first identification in the data processing device.

Moreover, the identification write unit may be configured to write, as the first identification, data indicative of one of predetermined analog quantity and a predetermined multi-level, and the identification detection unit may be configured to detect, as the second identification, data indicative of one of analog quantity and a multi-level and, based on a similarity between the one of the analog quantity and the multi-level which is indicated by the detected data and the one of the predetermined analog quantity and the predetermined multi-level, determine whether the first identification and the second identification match.

According to the above configuration, the novelty or similarity of the electronic data can flexibly be determined and the electronic data can be stored without redundancy and omission of electronic data.

Moreover, the identification write unit may be configured to write, as the first identification, predetermined multi-dimensional array of data, and the identification detection unit may be configured to detect multi-dimensional array of data as the second identification, and based on a similarity between the detected multi-dimensional array of data and the predetermined multi-dimensional array of data, determine whether the first identification and the second identification match.

According to the above configuration, the novelty or similarity of the electronic data can more accurately and readily be determined and the electronic data can be stored without redundancy and omission of electronic data.

Moreover, the identification write unit may be configured to write the first identification to the electronic data by embedding the first identification as a digital watermark into the electronic data, and the identification detection unit may be configured to detect the second identification by detecting a digital watermark embedded in the electronic data inputted from the data processing device.

According to the above configuration, the novelty or similarity of the electronic data can appropriately be determined while reducing degradation of the electronic data, and the electronic data can be stored without redundancy and omission of electronic data.

Moreover, the electronic data may include content data, and the identification write unit may be configured to write the first identification to the electronic data in a manner that the first identification is altered when the content data is modified, in accordance of an extent of modification of the content data.

According to the above configuration, determination is possible as to whether the modified electronic data is to be stored, in accordance with the extent of modification of the electronic data.

Moreover, the electronic data may include content data, the identification write unit may be configured to write the first identification to a region in which the content data is stored in the electronic data, and the identification detection unit may be configured to detect the second identification from the region in which the content data is stored in the electronic data.

According to the above configuration, the first identification can be written to the content data.

Moreover, the identification write unit may be configured to write the first identification to a substantially entirety of the region in which the content data is stored in the electronic data.

According to the above configuration, the first identification cab be written to the substantially entirety of the region in which the content data is stored. Thus, the amount of information on the identification can be increased and the accuracy in determining whether the first identification and the second identification match can be enhanced.

Moreover, the identification write unit may be configured to write the first identification to a portion of the region in which the content data is stored in the electronic data.

According to the above configuration, the degradation of the content data can be further reduced as compared to the case where the first identification is written to the entirety of the region in which the content data is stored.

Moreover, the identification write unit may be configured to write the first identification to a portion to be read initially of the region in which the content data is stored in the electronic data.

According to the above configuration, the second identification can be detected early in time and the determination as to whether the first identification and the second identification match can be made efficiently, without waiting for the completion of reading all the content data.

Moreover, the identification detection unit may be configured to calculate a correlation value between the first identification and the second identification, as the similarity.

According to the above configuration, determination can be made as to whether the first identification and the second identification match, based on the correlation value between the first identification and the second identification, and the novelty or similarity of the electronic data can be determined more appropriately.

Moreover, the identification detection unit may be configured to determine that the first identification and the second identification match if the correlation value is greater than or equal to a predetermined reference value, and determine that the first identification and the second identification do not match if the correlation value is smaller than the predetermined reference value.

According to the above configuration, the comparison between the correlation value and the reference value allows for the determination as to whether the first identification and the second identification match, and appropriate and flexible determination as to the novelty or similarity of the electronic data.

Moreover, the identification write unit may be configured to write a predetermined code sequence as the first identification in the electronic data, and the identification detection unit may be configured to detect a code sequence as the second identification, and determine whether the detected code sequence and the predetermined code sequence match, to determine whether the first identification and the second identification match.

According to the above configuration, determination can readily be made as to whether the first identification and the second identification match, and the novelty of the electronic data can accurately and readily be determined.

Moreover, the electronic data may include content data and related data indicative of information on the electronic data, the identification write unit may be configured to write the first identification to a region in which the related data is stored in the electronic data, and the identification detection unit may be configured to detect the second identification from the region in which the related data is stored in the electronic data.

According to the above configuration, the first identification can be written into the electronic data, without the degradation of the content data.

Moreover, the data management device may further include an identification removal unit configured to remove the second identification from the electronic data inputted from the data processing device if it is determined that the first identification and the second identification do not match, wherein the selection unit may be configured to record into the storage device the electronic data from which the second identification has been removed by the identification removal unit.

According to the above configuration, since the identification that has previously been written to the electronic data can be removed, the degradation of the electronic data caused by the identification being written redundantly can be reduced.

Moreover, the first identification may be information unique to the data management device.

According to the above configuration, even if a plurality of data management devices exists, the novelty or similarity of the electronic data can appropriately and readily be determined and the electronic data can be stored redundancy and omission of electronic data.

Moreover, the data management device may further include an identification write control unit configured to control whether to cause the identification write unit to write the first identification to the electronic data, in accordance with functionality of the data processing device.

According to the above configuration, the write operation can be controlled in accordance with the functionality of the data processing device, thereby reducing the overhead of the electronic data and reducing an amount of data transfer.

It should be noted that the present invention can be implemented not only as such a data management device, but also as a data management method which includes the distinguishing components included in the data management device as steps. Moreover, the present invention can be implemented as a program for causing a computer to execute each step included in the data management method. In addition, such a program can, of course, be distributed by being stored in a storage medium such as CD-ROM (Compact Disc Read Only Memory) or via a transmission medium such as the Internet.

Moreover, the present invention can also be implemented as an integrated circuit which includes the components included in the data management device.

### Advantageous Effects of Invention

According to the data management device of one aspect of the present invention, since the data management device is allowed to write the identification into the electronic data, processing load increase in the data processing device can be reduced. Moreover, when the first identification and the second identification which is detected in the electronic data inputted from the data processing device do not match, the image data can be stored by recording the electronic data into the storage device, thereby the redundancy and omission of image data can be prevented.

### BRIEF DESCRIPTION OF DRAWINGS

FIG. 1 is a block diagram showing a configuration of a data management system according to a first embodiment of the present invention.

FIG. 2 is a flowchart illustrating a processing flow in a data management device according to the first embodiment of the present invention.

FIG. 3 is a schematic view showing an example of a writing area for identification according to the first embodiment of the present invention.

FIG. 4 is a block diagram showing a configuration of a data management system according to a variation 1 of the first embodiment of the present invention.

FIG. 5 is a diagram showing an example of identification managed by an identification management unit according to the variation 1 of the first embodiment of the present invention.

FIG. 6 is a block diagram showing a configuration of a data management system according to a variation 2 of the first embodiment of the present invention.

FIG. 7 is a flowchart illustrating a processing flow in a device determination unit and an identification write control unit according to the variation 2 of the first embodiment of the present invention.

FIG. 8 is a block diagram showing a configuration of a data management system according to a second embodiment of the present invention.

FIG. 9 is a flowchart illustrating a processing flow in a data management device according to the second embodiment of the present invention.

FIG. 10 is a schematic view showing an example of identification according to the second embodiment of the present invention.

FIG. 11 is a graph illustrating degradation of the identification caused by processing (such as modification and editing) image data in the second embodiment of the present invention.

FIG. 12 is a block diagram showing a configuration of a data management system according to a variation of the second embodiment of the present invention.

FIG. 13 is a block diagram showing another configuration of the data management device according to the first embodiment or the second embodiment of the present invention.

FIG. 14 is a block diagram showing a configuration of a conventional data management system.

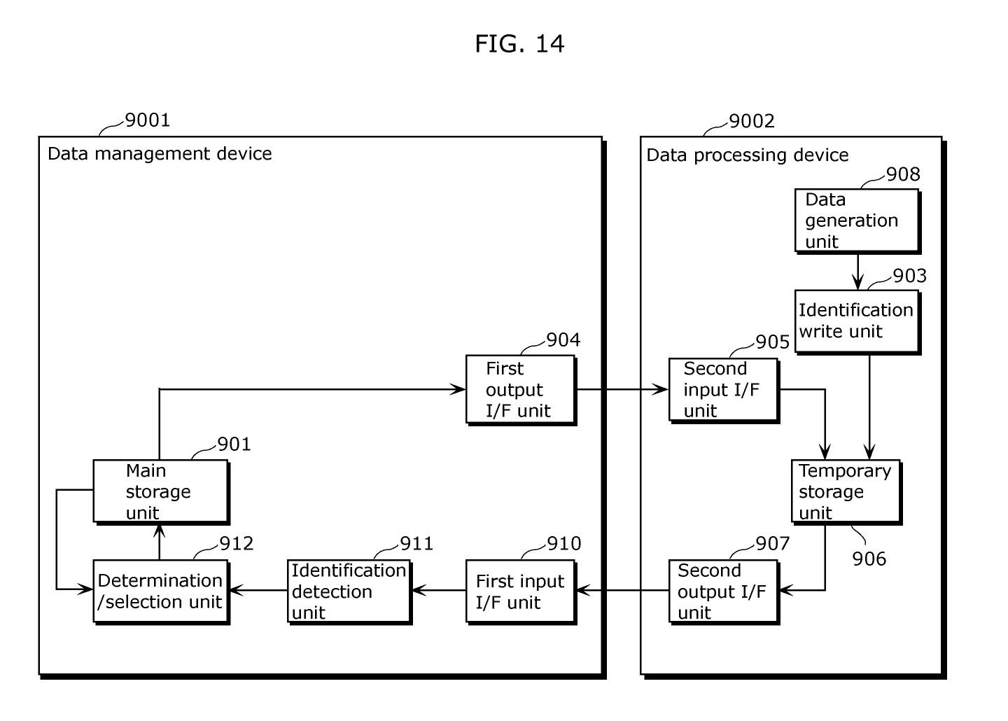

### DESCRIPTION OF EMBODIMENTS

Hereinafter, embodiments of the present invention will be described, with reference to the accompanying drawings. It should be noted that a case will be described where content data is image data indicative of a still image or a video. However, the content data is not limited to image data. For example, the content data may be audio data or document data. Alternatively, for example, the content data may be a combination of image data, audio data, and document data.

### First Embodiment

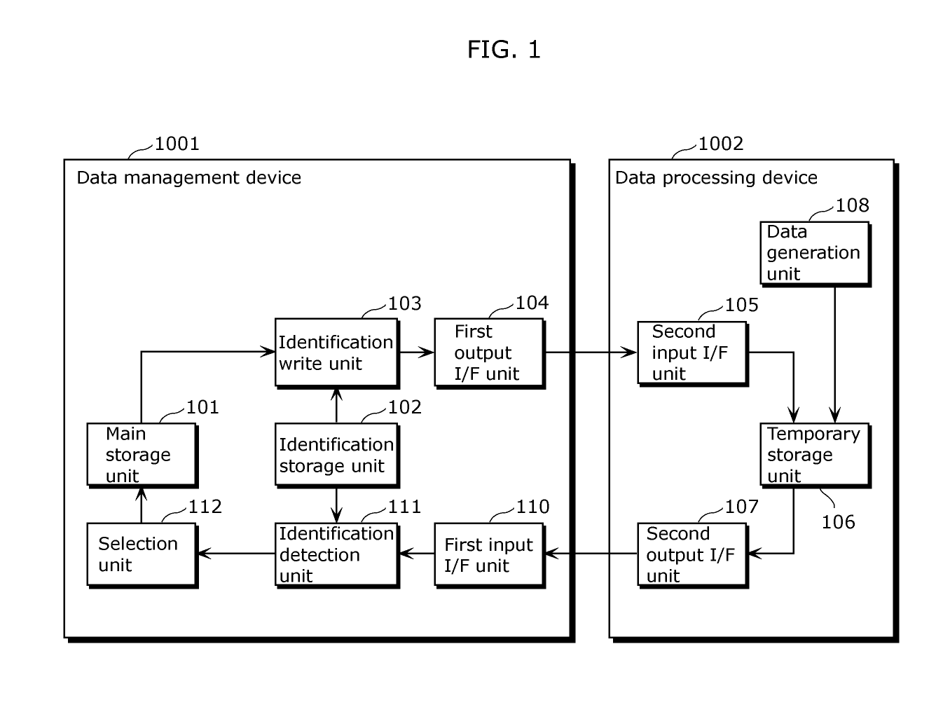

FIG. 1 is a diagram showing a configuration of a data management system according to a first embodiment of the present invention. As shown in FIG. 1, the data management system includes a data management device 1001 and a data processing device 1002.

First, the data management device 1001 will be described.

The data management device 1001 is a device which centrally stores therein image files acquired from the data processing device 1002.

Here, the image file is a set of image data and other data. In the present embodiment, the image file includes image data and related data indicating information related to the image file.

The data management device 1001 includes a main storage unit 101, an identification storage unit 102, an identification write unit 103, a first output I/F unit 104, a first input I/F unit 110, an identification detection unit 111, and a selection unit 112.

The main storage unit 101 corresponds to a storage device, examples of which include HDDs (hard disk drive) and SSDs (solid state drive). Image files are saved in the main storage unit 101.

First identification previously set to the data management device 1001 is saved in the identification storage unit 102.

The identification write unit 103 writes the first identification into the image file saved in the main storage unit 101. The identification write unit 103 then outputs the image file having the written first identification to the data processing device 1002 via the first output I/F unit 104.

The first output I/F unit 104 outputs the image file to the data processing device 1002.

The first input I/F unit 110 receives input of the image file from the data processing device 1002.

The identification detection unit 111 detects second identification written in the image file inputted via the first input I/F unit 110 from the data processing device 1002. The identification detection unit 111 then determines whether the first identification and the second identification match.

It should be noted that if the identification detection unit 111 detects a plurality of pieces of the second identification, and if at least one of the pieces of second identification matches the first identification, the identification detection unit 111 determines that the first identification and the second identification match.

If the identification detection unit 111 cannot detect the identification, the identification detection unit 111 detects, for example, “NULL” as the second identification. In other words, if the identification detection unit 111 cannot detect the second identification, the identification detection unit 111 determines that the first identification and the second identification do not match.

The selection unit 112 records the image file into the main storage unit 101 or discards the image file, in accordance with a result of determining the identification. Specifically, if it is determined that the first identification and the second identification do not match (including the case where the second identification is not detected), the selection unit 112 records, into the main storage unit 101, the image file inputted from the data processing device 1002. On the other hand, if it is determined that the first identification and the second identification match, the selection unit 112 discards the image file inputted from the data processing device 1002, without recording the inputted image file into the main storage unit 101.

Next, the data processing device 1002 will be described.

Examples of the data processing device 1002 include digital cameras, AV equipment such as DVD recorder, mobile phones, and client devices such as personal computers (PC). It should be noted that the data processing device 1002 may not necessarily be the client device and may be, for example, a server device for providing network services such as storing/accumulating or processing the image files, or allowing the image files to be viewed.

The data processing device 1002 accepts the image file from the data management device 1001 and outputs the image file to the data management device 1001. The data processing device 1002 includes a second input I/F unit 105, a temporary storage unit 106, a second output I/F unit 107, and a data generation unit 108.

The second input I/F unit 105 accepts input of the image file from the data management device 1001.

The image file is recorded in the temporary storage unit 106.

The second output I/F unit 107 outputs the image file to the data management device 1001.

The data generation unit 108 generates image data. Specifically, the data generation unit 108 generates the image data, using, for example, an imaging device or the like. The data generation unit 108 then records the generated image data into the temporary storage unit 106.

In other words, the image data outputted from the data generation unit 108 or the image data inputted to the data processing device 1002 by other means is recorded as the image file into the temporary storage unit 106. Here, the other means is assumed to be a method to remove the temporary storage unit 106 itself out of the data processing device 1002 and connect the temporary storage unit 106 to other device, and directly write the image file or the like to the temporary storage unit 106.

In a state in which the data processing device 1002 and the data management device 1001 are physically or logically in connection, the second output I/F unit 107 reads and outputs all the image files recorded in the temporary storage unit 106 to the data management device 1001.

Next, operation of the data management device 1001 arranged as set forth above will be described.

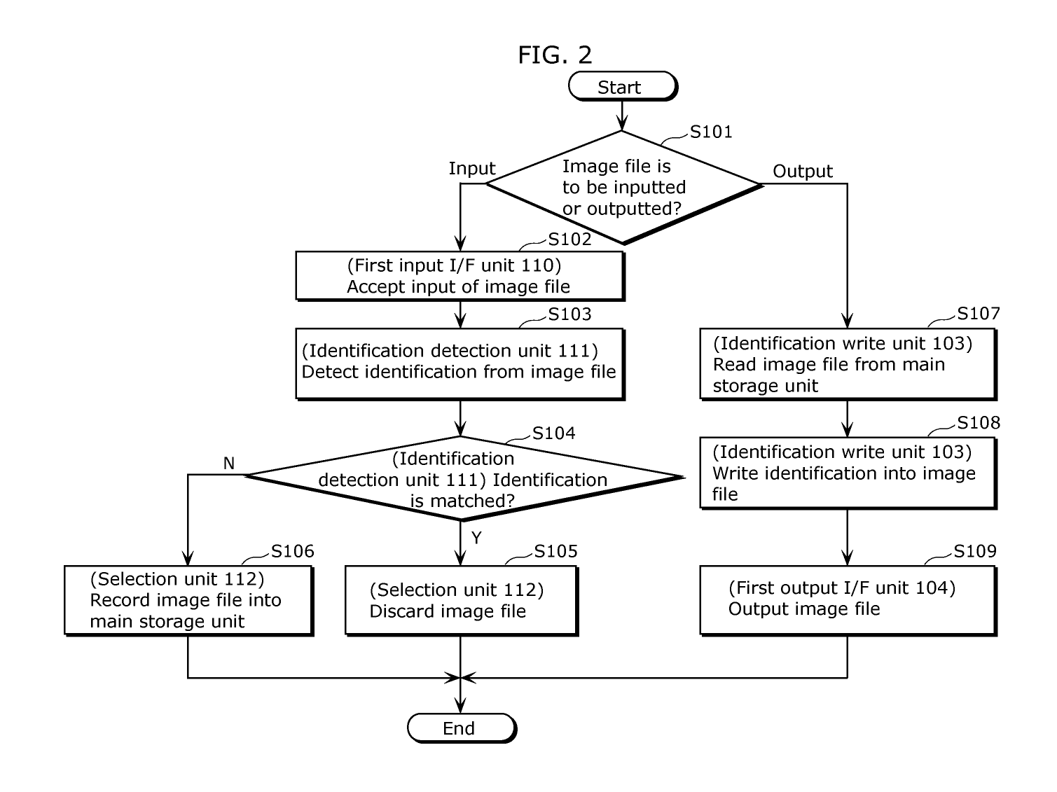

FIG. 2 is a flowchart illustrating a processing flow of the data management device according to the first embodiment of the present invention.

Here, it is assumed, as an initial state before the processing shown in FIG. 2 is performed, that the image files are saved in the main storage unit 101 and the first identification that is previously set to the data management device 1001 is saved in the identification storage unit 102.

In such a state, the data management device 1001 first determines whether the image file is to be inputted thereto or outputted therefrom (S101).

When the image file is to be inputted (input in S101), the first input I/F unit 110 accepts input of the image file outputted from the second output I/F unit 107 (S102). Subsequently, the identification detection unit 111 detects the second identification from the accepted image file (S103).

The identification detection unit 111 reads the first identification saved in the identification storage unit 102 to determine whether the read first identification and the detected second identification match (S104). In other words, the identification detection unit 111 determines whether the first identification can be detected from accepted image file.

The selection unit 112 records the image file into the main storage unit 101, in accordance with a result of determination by the identification detection unit 111. Specifically, if it is determined that the first identification and the second identification match (Y in S104), the selection unit 112 discards the image file (S105). On the other hand, if it is determined that the first identification and the second identification do not match (N in S104), the selection unit 112 records the image file into the main storage unit 101 (S106).

It should be noted that, herein, when it is determined that the first identification and the second identification match, the selection unit 112 discards the image file. The selection unit 112, however, does not necessarily discard the image file. For example, when it is determined that the first identification and the second identification match, the selection unit 112 may display, on a display device (not shown), a screen whereby a user is prompted for confirmation as to whether to record the image file into the main storage unit 101, and based on a result of input by the user to the displayed screen, the selection unit 112 may record or discard the image file.

When the image file is to be outputted (output in S101), the identification write unit 103, as necessary, reads all or portion of the image files saved in the main storage unit 101 (S107). Subsequently, the identification write unit 103 writes into the read image files the first identification saved in the identification storage unit 102 (S108).

The first output I/F unit 104 then outputs the image files having the written first identification to the data processing device 1002 (S109). Specifically, in a state in which the data management device 1001 and the data processing device 1002 are physically or logically in connection, the first output I/F unit 104 outputs, to the data processing device 1002, the image files outputted from the identification write unit 103.

At this time, in the data processing device 1002, the second input I/F unit 105 receives the image files outputted from the first output I/F unit 104 and outputs the image files to the temporary storage unit 106. The image files outputted from the second input I/F unit 105 are recorded into the temporary storage unit 106.

As described above, by the data management device 1001 writing the first identification into the image files, it is easily identifiable that the image files outputted from the data management device 1001 are saved in the data management device 1001. An example of the image files that have the written first identification will be described below.

It should be noted that in the present embodiment, in the state in which the data management device 1001 and the data processing device 1002 are physically or logically in connection, the all or portion of the image files possessed by the data processing device 1002 are transferred to the data management device 1001. On the other hand, the same image files as those possessed by the data management device 1001 are transferred from the data management device 1001 to the data processing device 1002 if it is necessary that the image files are also held redundantly in the data processing device 1002. However, the data processing device 1002 that outputs the image files to the data management device 1001 and the data processing device 1002 that accepts input of the image files from the data management device 1001 are not necessarily limited to the same individual, and may be different individuals.

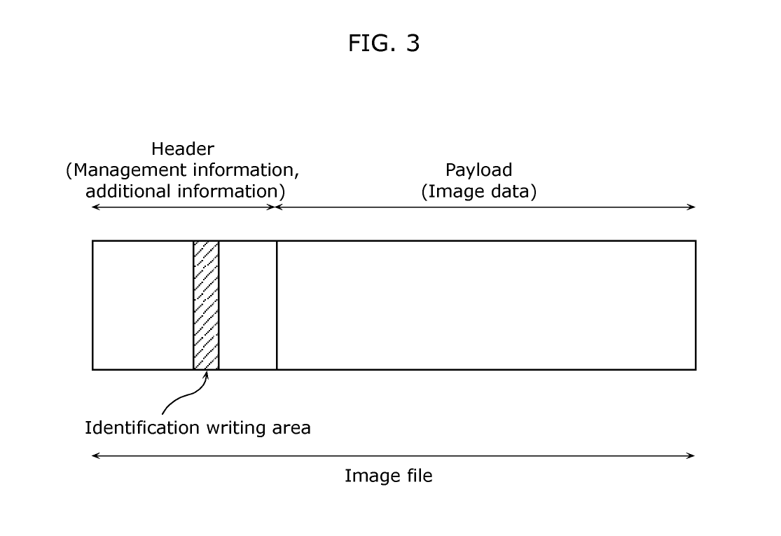

FIG. 3 is a schematic view showing an example of a writing area for the identification according to the first embodiment of the present invention. In other words, FIG. 3 is an explanatory diagram regarding the first identification written to the image files by the identification write unit 103, and the second identification detected from the image files by the identification detection unit 111.

As shown in FIG. 3, for example, the first identification is written to a header region or the like which is outside an image data (payload) region in the image file. Specifically, the identification write unit 103 writes the first identification in a region in which the related data is stored in the image file. In other words, the identification write unit 103 writes the first identification into the related data in the image file. This allows the identification write unit 103 to write the first identification into the image file without degradation of the image data.

Moreover, the identification detection unit 111 detects the second identification from the region in which the related data is stored in the image file. In other words, the identification detection unit 111 detects the second identification from the related data in the image file.

It should be noted that the header region is by way of example of a region into which the first identification is to be written. The region into which the identification is to be written is not limited to the header region.

Preferably, the region (hereinafter, referred to as “identification writing area”) into which the identification is to be written is set to a region usually not accessed by the data processing device 1002. This inhibits the data processing device 1002 from inadvertently rewriting the identification. In other words, the data management device 1001 can inhibit the image file that includes the image data previously saved in the main storage unit 101 from being redundantly recorded into the main storage unit 101.

Moreover, preferably, the specific form of the identification is, for example, multiple bits of digital signals (a series of data made up of “1” and “0”) having a predetermined pattern, or multiple bits of substantially random digital signals. In other words, preferably, the identification write unit 103 writes a predetermined code sequence as the first identification. This allows the identification detection unit 111 to compare a code sequence detected from the image file and the predetermined code sequence, thereby readily determining whether the first identification and the second identification match.

As described above, in the present embodiment, when the image file is to be outputted from the data management device 1001, the data management device 1001 writes, to a predetermined region in the image file, the first identification indicating that the image data included in the image file is “saved” in the data management device 1001. The data management device 1001 then outputs the image file having the written first identification to the data processing device 1002.

Meanwhile, when the image files are inputted from various data processing devices 1002 to the data management device 1001, the data management device 1001 detects the second identification written into the image files, and determines whether the detected second identification and previously held first identification match. Then, the data management device 1001 records the image files into the main storage unit 101 only when the first identification and the second identification do not match. This allows the data management device 1001 to accurately determine the novelty of the image data without increasing the load on the data processing device 1002 and store the image data without redundancy and omission of image data.

As described above, according to the first embodiment of the present invention, when the image file or the like saved in AV equipment such as a digital camera are to be transferred to the data management device such as a PC which includes the hard disk or the like, the data management device 1001 is allowed to readily determine whether the image data included in the image file is image data previously saved in the data management device 1001, based on presence or absence of the first identification in the image file transferred from the AV equipment. Thus, the data management device 1001 can obviate recording redundantly the image data previously saved in the main storage unit 101. In other words, the data management device 1001 can appropriately store only the image data that is not yet stored by the data management device 1001, such as image data newly generated in the AV equipment and image data transferred from other recording device.

In other words, according to the first embodiment, in the data management system in which the image data is inputted/outputted to/from a plurality of devices, by providing to the image data saved in a storage device (the data management device) the first identification indicating that the image data is “saved”, the determination can readily be achieved as to whether the image data circulated among the devices is the image data previously saved in the storage device or new (unsaved) image data, without increasing the load on the data processing device. Moreover, when the first identification and the second identification do not match, the data management device records the electronic data into the storage device, thereby accurately and efficiently storing the image data, without requiring the data processing device for special processing, and without redundancy and omission of image data.

### Variation 1 of First Embodiment

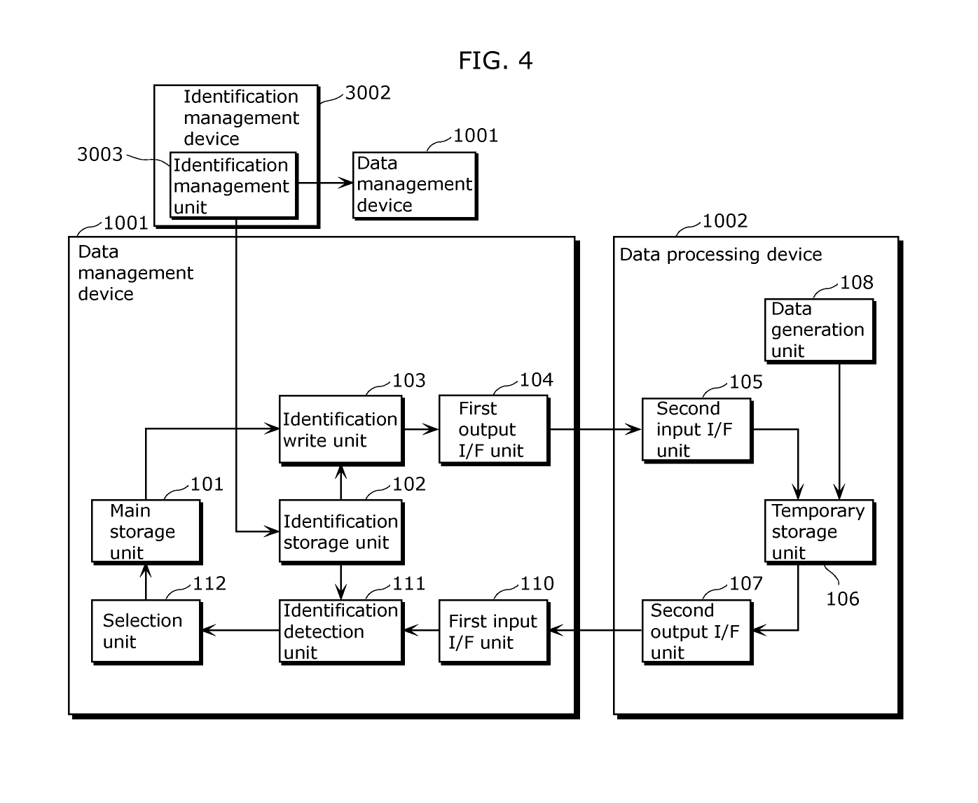

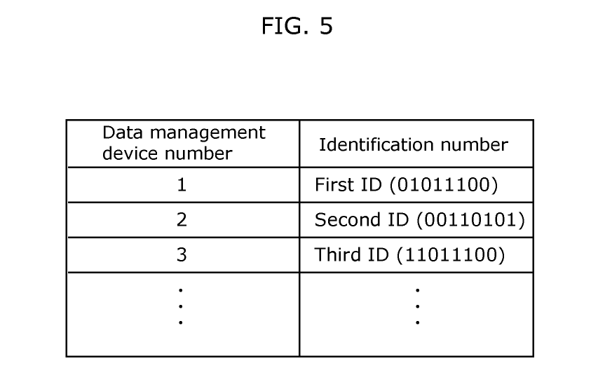

Next, a variation 1 of the first embodiment will be described, with reference to FIG. 4 and FIG. 5.

In a data management system according to the present variation, the first identification to be written into the image file is managed by an identification management device so as to be information unique to the data management device, which is different from the data management system according to the first embodiment.

FIG. 4 is a block diagram showing a configuration of the data management system according to the variation 1 of the first embodiment of the present invention. In FIG. 4, the data management system includes a plurality of the data management devices 1001 and an identification management device 3002. It should be noted that the same reference signs will be used in FIG. 4 to refer to the same components as shown in FIG. 1 and the description will be omitted.

The identification management device 3002 is connected to each of the data management devices 1001 via a network or the like, and includes an identification management unit 3003.

The identification management unit 3003 assigns unique identification having uniqueness, to each data management device.

FIG. 5 is a diagram showing an example of an identification table held by the identification management unit 3003. As such, the identification management unit 3003 allocates to the plurality of data management devices (1, 2, 3, and so on) identification (a first ID, a second ID, a third ID, and so on) that has different code sequences or different code patterns. The allocated identification is utilized in each data management device 1001, and thus, it is identifiable that which data management device 1001 the image file is stored. In other words, each data management device 1001 can determine the image data saved in the own data management device 1001 even under a circumstance where the plurality of data management devices 1001 exists. As a result, each data management device 1001 can record, into the main storage unit 101 of the own data management device 1001, the image data saved in other data management device, rather than newly recording the image data saved in the own data management device 1001 into the main storage unit 101 of the own data management device 1001.

It should be noted that the identification table shown in FIG. 5 is by way of example of information for managing the identification unique to each data management device 1001, and the identification management unit 3003 does not necessarily utilize a table to manage the identification.

As described above, according to the data management device 1001 of the present variation, even when the plurality of data management devices exists, the novelty or similarity of the electronic data can appropriately and readily be determined, and stored without redundancy and omission of electronic data.

### Variation 2 of First Embodiment

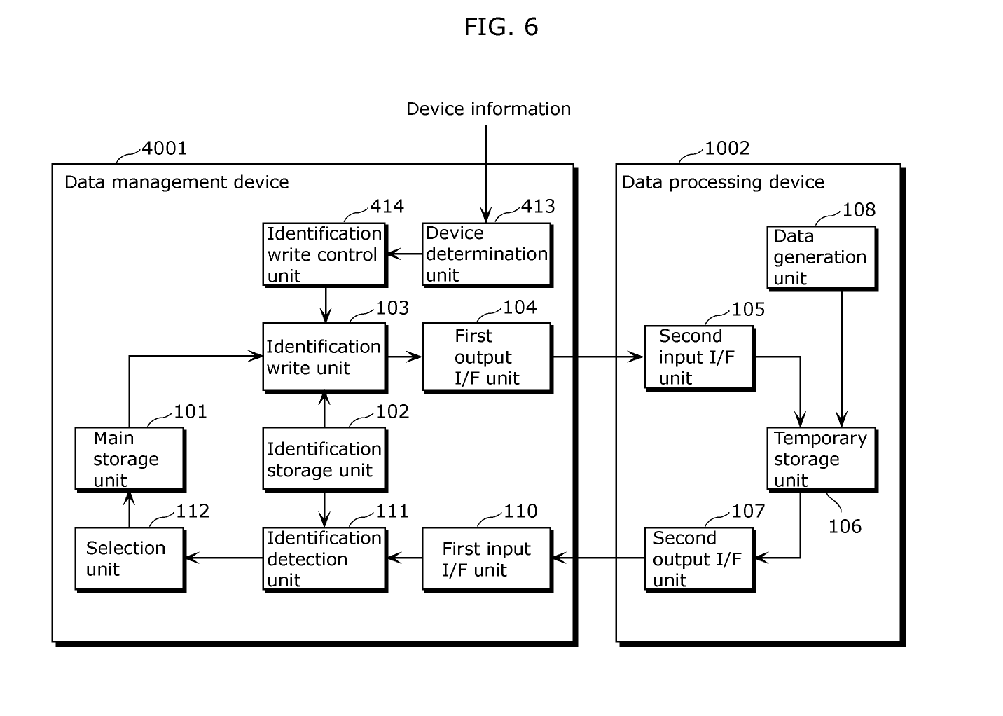

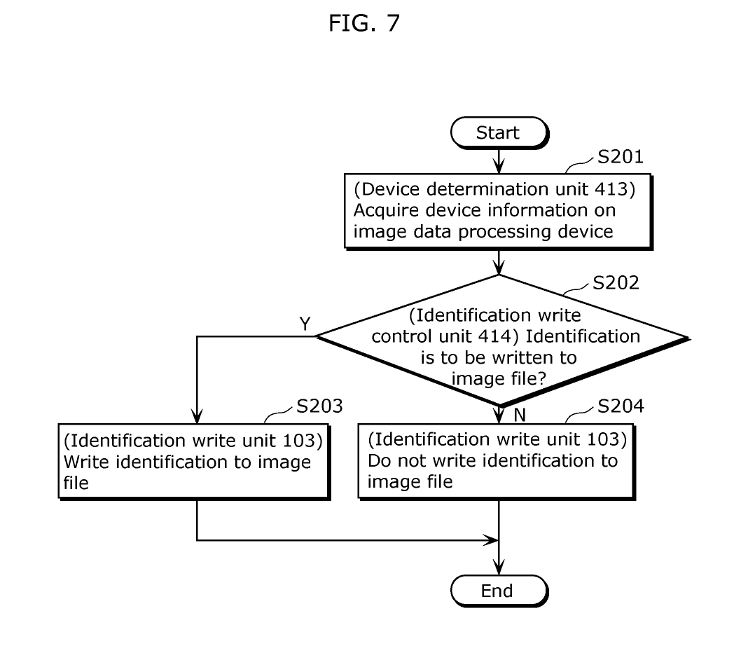

Next, a variation 2 according to the first embodiment will be described, with reference to FIG. 6 and FIG. 7. A data management device according to the present variation determines whether to write the identification into the image file, in accordance with the functionality of the data processing device, which is different from the data management device according to the first embodiment.

FIG. 6 is a block diagram showing a configuration of the data management system according to the variation 2 of the first embodiment of the present invention. A data management device 4001 according to the present variation further includes a device determination unit 413 and an identification write control unit 414, in addition to the components included in the data management device 1001 shown in FIG. 1. It should be noted that the same reference signs will be used in FIG. 6 to refer to the same components as shown in FIG. 1 and the description will be omitted.

The device determination unit 413 acquires device information. Specifically, the device determination unit 413 acquires the device information from, for example, the data processing device 1002. Also for example, the device determination unit 413 acquires the device information from a user via an input unit such as a keyboard and a mouse not shown.

Here, the device information is information on the data processing device 1002 to which the image file is outputted. Specifically, the device information is information for identifying, for example, type, configuration, functionality, individual, or the like of the data processing device 1002.

The identification write control unit 414 controls, based on the device information, whether to cause the identification write unit 103 to write the identification into the image file. In other words, the identification write control unit 414 controls whether to cause the identification write unit 103 to write the first identification into the image file, in accordance with the functionality of the data processing device 1002.

Next, operation of the device determination unit 413 and the identification write control unit 414 will be described.

FIG. 7 is a flowchart illustrating a processing flow in the device determination unit and the identification write control unit according to the variation 2 of the first embodiment of the present invention. It should be noted that the flowchart shown in FIG. 7 shows an alternate processing to that in S108 shown in FIG. 2. In other words, in the present variation, the processing steps other than S108 shown in FIG. 2 are the same as those shown in FIG. 2, and thus the illustration and description will be omitted.

First, the device determination unit 413 acquires the device information for identifying the type, configuration, functionality, individual, or the like of the data processing device 1002 connected to the data management device 4001 (S201). The device information is manually or automatically inputted to the device determination unit 413.

The identification write control unit 414 determines, based on the device information acquired by the device determination unit 413, whether the first identification is to be written into the image file for outputting the image file to the data processing device 1002 (S202), and outputs a result of the determination to the identification write unit 103.

If the identification write unit 103 accepts a determination result that the identification is to be written to the image file (Y in S202), the identification write unit 103 writes the identification to the image file read from the main storage unit 101 (S203). If the identification write unit 103 accepts a determination result that the identification is not to be written to the image file (N in S202), the identification write unit 103 does not write the identification to the image file (S204).

As described above, by controlling the operation of writing the identification, in accordance with the functionality of the data processing device 1002, the image file that has no written first identification can be outputted to the data processing device that merely has a relatively simple function such as display operation like a display device or the like, and does not have the functionality of processing or editing the image data or a function of outputting the image data or the like to the data management device 4001.

This can reduce the overhead of the image file and allow for more efficient image data transfer because the data management device 4001 does not need to provide the first identification to the image file that is to be outputted to the data processing device 1002 that requires no identification. In other words, when the image file outputted from the data management device 4001 to the data processing device 1002 is not likely to return to the data management device 4001, it is not necessary for the data management device 4001 to write the first identification into the image file. Thus, an amount of data transfer can be reduced.

### Second Embodiment

Next, a data management device according to a second embodiment of the present invention will be described.

In the present embodiment, identification is written to a region in which image data is stored, which is different from the first embodiment. Hereinafter, the second embodiment will be described, with reference to the accompanying drawings, focusing on the difference from the first embodiment.

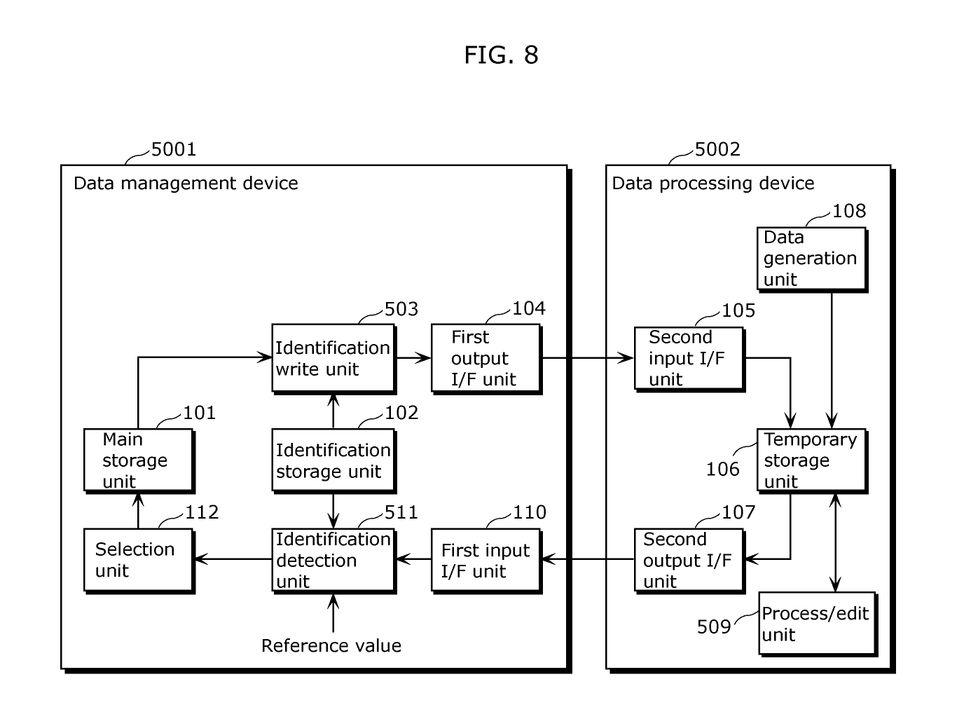

FIG. 8 is a block diagram showing a configuration of a data management system according to the second embodiment of the present invention. The same reference signs will be used in FIG. 8 to refer to the same components as shown in FIG. 1 and the description will be omitted.

A data management system according to the present embodiment includes a data management device 5001 and a data processing device 5002.

The data management device 5001 includes the main storage unit 101, the identification storage unit 102, an identification write unit 503, the first output I/F unit 104, the first input I/F unit 110, an identification detection unit 511, and the selection unit 112.

The data processing device 5002 includes the second input I/F unit 105, the temporary storage unit 106, the second output I/F unit 107, the data generation unit 108, and a process/edit unit 509.

The identification write unit 503 writes first identification to a region in which the image data is stored in the image file. In the present embodiment, the first identification is a predetermined two-dimensional array of data. Specifically, examples of the first identification include image data.

It should be noted that examples of the first identification include data indicative of predetermined analog quantity or a predetermined multi-level. The first identification may be, for example, three or more-dimensional array of data. The first identification as such allows the data management device 5001 to accurately and flexibly determine the novelty or similarity of the image data.

The identification detection unit 511 detects the second identification written to the region in which the image data is stored in the image file. Furthermore, the identification detection unit 511 reads the first identification saved in the identification storage unit 102. The identification detection unit 511 then determines whether the first identification and the second identification match, based on a similarity indicative of a degree of similarity between the read first identification and the detected second identification.

The process/edit unit 509 performs any image processing on the image data included in the image file, and records an image file that includes the image-processed image data into the temporary storage unit. Specifically, the process/edit unit 509 once reads the image file saved in the temporary storage unit 106 and performs any image processing on the image file, and then records again the resultant image file into the temporary storage unit 106.

Here, the any image processing refers to all of image processing involving modification of the image data, from image processing of relatively minor modifications, such as correcting gradation or color temperature of an image indicated by the image data to image processing of extensive editing such as image cropping or image synthesization. It should be noted that the data processing device 5002, but not necessarily, includes the process/edit unit 509 in FIG. 8. For example, the process/edit unit may be included in other device independent of the data processing device 5002. In that case, the data processing device 5002 acquires the processed or edited image data from the other device and records the acquired image data into the temporary storage unit 106.

Next, operation of the data management device 5001 arranged as set forth above will be described.

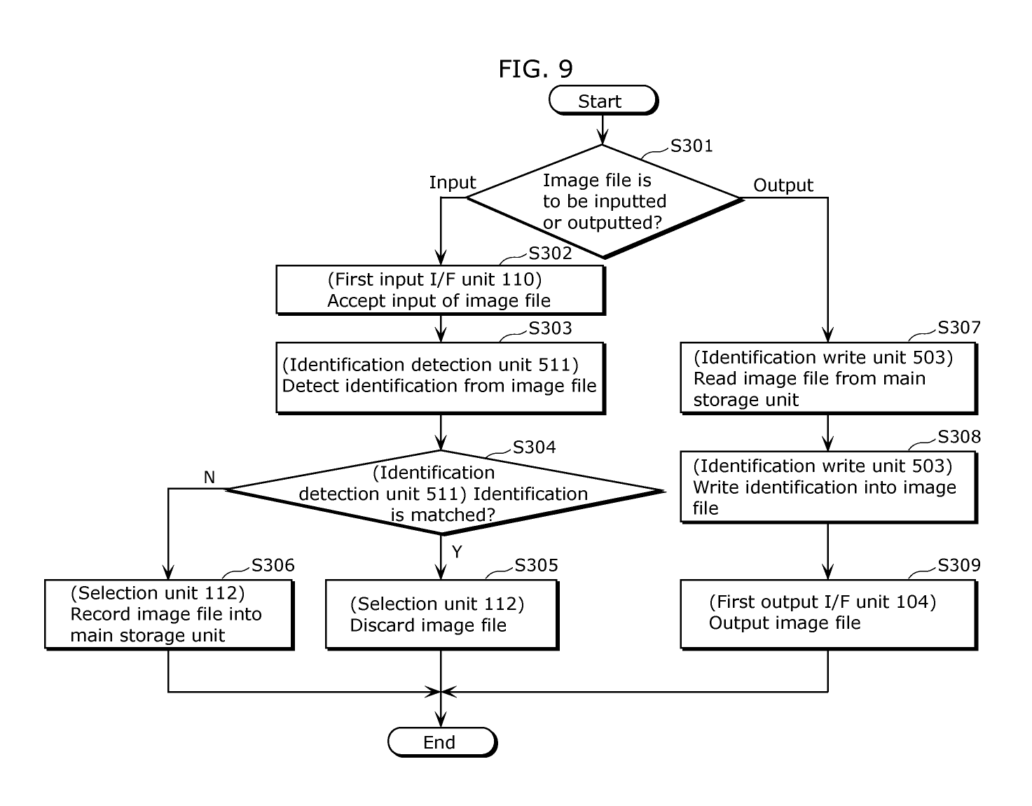

FIG. 9 is a flowchart illustrating a processing flow of the data management device according to the second embodiment of the present invention. It should be noted that it is assumed, as an initial state before the processing shown in FIG. 9 is performed, that the image file is saved in the main storage unit 101 and preset first identification is saved in the identification storage unit 102.

First, the data management device 5001 determines whether the image file is to be inputted or outputted to or from the data management device 5001 (S301).

When the image file is to be inputted (input in S301), the first input I/F unit 110 accepts input of the image file outputted from the second output I/F unit 107 (S302). Subsequently, the identification detection unit 511 detects the second identification from the accepted image file (S303).

The identification detection unit 511 reads the first identification saved in the identification storage unit 102, and determines whether the read first identification and the detected second identification match (S304).

Specifically, the identification detection unit 511 calculates, as the similarity, a correlation value between a two-dimensional array of data indicated by the first identification and a two-dimensional array of data indicated by the second identification. More specifically, the identification detection unit 511 calculates, as the similarity, the correlation value between, for example, image data indicated by the first identification and image data indicated by the second identification.

Furthermore, the identification detection unit 511 determines whether the first identification and the second identification match, in accordance with whether the correlation value satisfies a predetermined reference value. In other words, when the correlation value is greater than or equal to the predetermined reference value, the identification detection unit 511 determines that the first identification and the second identification match. On the other hand, when the correlation value is smaller than the predetermined reference value, the identification detection unit 511 determines that the first identification and the second identification do not match. It should be noted that operation of the identification detection unit 511 which determines, based on the similarity, whether the first identification and the second identification match will be described below.

The selection unit 112 records the image file into the main storage unit 101, in accordance with a result of the determination by the identification detection unit 511. In other words, when it is determined that the first identification and the second identification do not match (N in S504), the selection unit 112 records the image file into the main storage unit 101 (S306). On the other hand, when it is determined that the first identification and the second identification match (Y in S504), the selection unit 112 discards the image file (S305).

It should be noted that, herein, when it is determined that the first identification and the second identification match, the selection unit 112 discards the image file. The selection unit 112, however, does not necessarily discard the image file. For example, when it is determined that the first identification and the second identification match, the selection unit 112 may display, on a display device (not shown), a screen whereby a user is prompted for confirmation as to whether the image file is to be recorded into the main storage unit 101, and based on a result of input by the user to the displayed screen, the selection unit 112 may record or discard the image file. Moreover, when the correlation value between the image data indicated by the first identification and the image data indicated by the second identification is a predetermined value near the predetermined reference value, the selection unit 112 may cause the display device to display the same confirmation screen as mentioned above, and based on a result of input by a user to the displayed screen, the selection unit 112 may record or discard the image file.

When the image file is to be outputted (output in S301), the identification write unit 503 reads all or portion of the image files saved in the main storage unit 101, in accordance with, for example, request from the data processing device 5002 (S307). Subsequently, the identification write unit 503 writes the first identification saved in the identification storage unit 102 into the read image files (S308).

In the present embodiment, the identification write unit 503 writes the first identification into a region in which the image data is stored in the image file. More specifically, the identification write unit 503 writes the second identification, which is the two-dimensional array of data, into the image file, superimposed on the image data.

The first output I/F unit 104 outputs the image file having the written first identification to the data processing device 5002 (S309).

Next, the identification to be written into the image data in the present embodiment will be described.

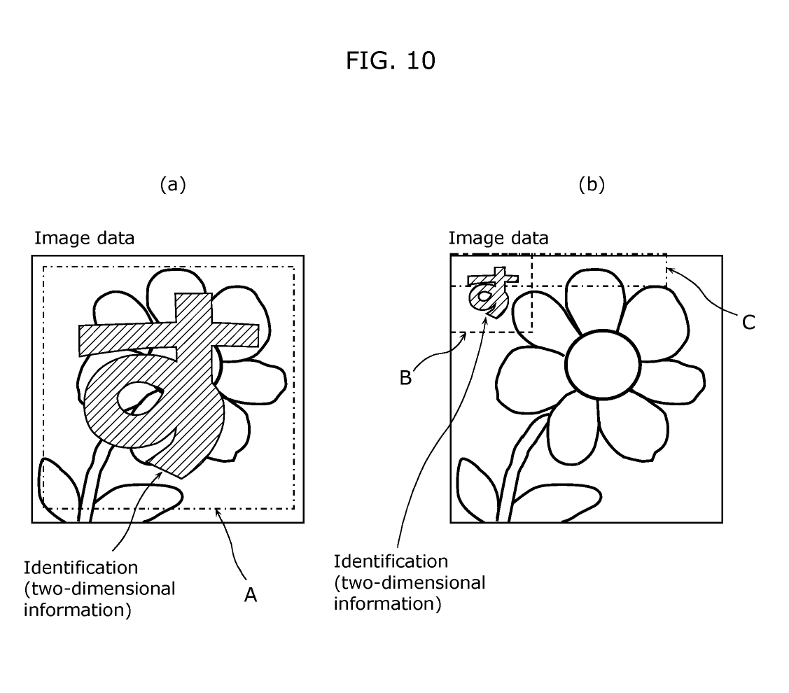

FIG. 10 is a schematic view showing an example of the identification according to the second embodiment of the present invention. As shown in FIG. 10, for example, the identification write unit 503 directly superimposes, as the first identification, two-dimensional information which is a two-dimensional array of data on the image data in the image file (displayed as “ [symbol] ” in FIG. 10). It should be noted that in FIG. 10, for purposes of description, the identification is displayed as if the identification is viewable. The identification, however, is not necessarily viewable.

More specifically, the identification write unit 503 embeds the first identification as a “digital watermark” in the image data, while minimizing the degradation of the original quality of image data as possible.

Here, the “digital watermark” is information embedded in content data such as the image data in such a manner that cannot be perceived by human. It should be noted that there are various techniques available to embed the “digital watermark” in the electronic data, and the technique according to the present embodiment is not necessarily limited to a particular technique.

For example, the identification write unit 503 may replace a pixel value of less significant bit plane with the first identification and thereby write the first identification superimposed on the image data. Alternatively, for example, the identification write unit 503 may write the first identification superimposed on the image data in a frequency domain.

As described above, the data management device 5001 embeds the digital watermark as the first identification in the image data and thus can reduce the degradation of the image data, appropriately determine the novelty or similarity of the image data, and store the image data without redundancy and omission of image data.

Here, the region to which the first identification is written or the region from which the second identification is detected will be described.

The identification write unit 503, as shown in (a) of FIG. 10, may superimpose the first identification over the entirety of a region (A) of the image indicated by the image data. In other words, the identification write unit 503 may write the first identification to substantially the entirety of the region in which the image data is stored. This allows for an increased amount of information on the identification and thus allows the data management device 5001 to enhance the accuracy in determining whether the first identification and the second identification match. It should be noted that substantially the entirety of the region means the entirety of the region and a region having a size sufficiently regarded as the entirety of the region.

Alternatively, the identification write unit 503 may, as shown in (b) of FIG. 10, superimpose the first identification on a portion (B, C) of the region of the image data. In other words, the identification write unit 503 may write the first identification to a portion of the region in which the image data is stored. This can reduce degradation of the image data.

Particularly in the latter case, preferably, the identification write unit 503 superimposes the first identification on a region that is initially read when the image data recorded in a memory, recording medium or the like is read. Specifically, preferably, the identification write unit 503 writes the first identification to a portion that is initially read, of a region in which the image data is stored in the image file. This allows the identification detection unit 511 to detect the second identification early in time, without waiting for the completion of reading of all the image data, and efficiently determine whether the first identification and the second identification match.

It should be noted that, preferably, the identification write unit 503 writes the first identification to the image data in such a manner that the first identification is altered in accordance with the extent of modification of the image data. Specifically, preferably, the first identification is, for example, information having a pattern or size associated with the body of image data so as to easily be degraded due to processing/editing the image data.

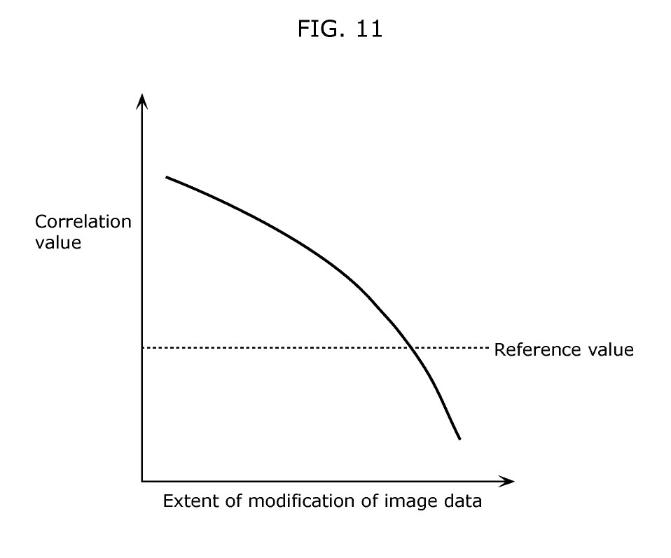

This causes alteration or degradation of the amount of information (such as a pattern and numeric value) of the first identification when the process/edit unit 509 processes or edits the image data. For example, as shown in FIG. 11, the correlation value (the graph ordinate) indicating the correlation between the original identification and altered identification decreases as the extent of modification (the graph abscissa) of the image data increases.

Thus, in such a case, the identification detection unit 511 calculates, as the similarity, the correlation value between the first identification and the second identification, and determines that the first identification and the second identification match if the calculated correlation value is greater than or equal to the predetermined reference value. In contrast, if the calculated correlation value is smaller than the predetermined reference value, the identification detection unit 511 determines that the first identification and the second identification do not match.

As a result, the identification detection unit 511 can determine, as new data, image data that has undergone modification to a certain extent or greater by being processed/edited, even if the image data is previously saved in the main storage unit 101. In other words, the data management device 5001 can determine whether to store the modified image data as new data, in accordance with the extent of modification of the image data.

It should be noted that the reference value utilized for the determination may, for example, be previously set by a user, and alternatively may be held in the identification detection unit 511. In this case, the identification detection unit 511 may acquire the held reference value and compares the acquired reference value with the correlation value to determine whether the first identification and the second identification match.

As described above, in the present embodiment, when the image file is to be outputted from the data management device 5001, the data management device 5001 writes, to an image data region of the image file, the first identification indicating that the image data included in the image file is “saved” in the data management device 5001, as the two-dimensional information. The data management device 5001 then outputs an image having the written first identification to the data processing device 5002.

On the other hand, when the image data is inputted from various data processing devices 5002 to the data management device 5001, the data management device 5001 detects the second identification in the image data region, and quantifies and compares the detected second identification and the first identification. The data management device 5001 then records the image file into the main storage unit 101 only if a result of the comparison satisfies predetermined criteria. This allows the data management device 5001 to determine, without increasing the load on the data processing device 5002, the novelty, similarity, or degree of image processing performed on the image data, and store the image data without redundancy and omission of image data.

As described above, according to the second embodiment of the present invention, when the image data or the like saved in the AV equipment such as digital cameras are to be transferred to the data management device such as a PC which includes the hard disk or the like, the data management device 5001 is allowed to readily determine whether the image data included in the image file is image data previously saved in the data management device 5001, based on the similarity between the second identification and the first identification embedded in the image data. Thus, the data management device 5001 can obviate recording redundantly the image data previously saved in the main storage unit 101. In other words, the data management device 5001 can extract and appropriately store only the image data that is not yet stored in the data management device 5001, such as image data newly generated in the AV equipment, image data transferred from other recording device, or image data obtained by processing or editing original image data outputted from the data management device 5001.

In other words, according to the second embodiment, in the data management system in which the image data is inputted/outputted to/from a plurality of devices, by providing the image data saved in a main storage device (the data management device) with the first identification indicating that the image data is “saved”, the determination can readily be achieved as to whether the image data circulated among the devices is the image data previously saved in the main storage device, new (unsaved) image data, or the image data obtained by processing or editing the saved image data, without increasing the load on the data processing device. This allows the data management device to accurately and efficiently store the image data including, of course, the original image data, and also the image data created by image processing the original image data, without redundancy of omission of image data.

It should be noted that in the present embodiment, the case is described where the electronic data to which the first identification is written is image data. However, the electronic data may be, for example, audio data or the like. In this case, the identification write unit 503 may, for example, write the first identification to a region in which data indicative of a non-audible sound is stored. Specifically, the identification write unit 503 may, for example, write the first identification superimposed on data indicative of a non-audible sound.

### Variation of Second Embodiment

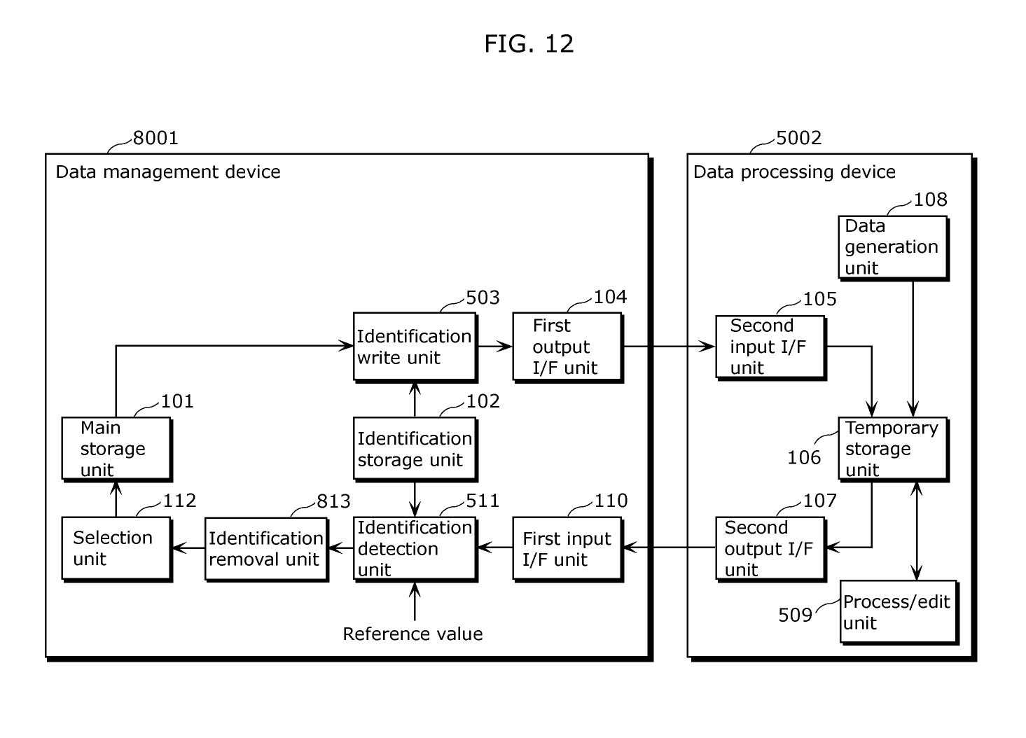

Next, a variation according to the second embodiment of the present invention will be described, with reference to FIG. 12. A data management device 8001 according to the present variation is different from the data management device 5001 according to the second embodiment in that, when it is determined that the first identification and the second identification do not match, the second identification is removed from the image file in the present variation.

FIG. 12 is a block diagram showing a configuration of a data management system according to the variation of the second embodiment of the present invention. The same reference signs will be used in FIG. 12 to refer to the same components as shown in FIG. 8 and the description will be omitted.

As shown in FIG. 12, the data management device 8001 according to the present variation further includes an identification removal unit 813, in addition to the components included in the data management device 5001 shown in FIG. 8.

When it is determined that the first identification and the second identification do not match, the identification removal unit 813 removes the second identification from the image file inputted from the data processing device 5002. Specifically, the identification removal unit 813 removes the identification from the image data determined as the original image data saved in the main storage unit 101 being processed or edited by the identification detection unit 511 (a correlation value with the original identification is less than a reference value R), and outputs resultant image data to the selection unit 112.

This allows the data management device 5001 to remove the identification remaining in the region in which the image data created by image processing the image data saved in the main storage unit 101, thereby storing image data having higher quality. In other words, the data management device 5001 can remove the identification previously written to the image data, and thus the data management device 5001 can reduce the degradation of the image data caused by the identification being written, and save the image data.

As described above, the data management device according to one aspect of the present invention has been described with reference to the embodiments and variations thereof. However, the present invention is not limited to the embodiments and variations thereof. Various modifications to the embodiments and variations that may be conceived by those skilled in the art and other embodiments constructed by combining constituent elements in different embodiments or variations are included in the scope of the present disclosure, without departing from the essence of the present disclosure.

For example, while in the first embodiment and the second embodiment, the identification is provided to the image file by the identification write unit included in the data management device, other device connected to the data management device may provide the identification to the image file. In this case, the other device may include the identification write unit. This can reduce processing load increase caused by providing the identification to the image file in the data management device.

Moreover, the data management device 5001 according to the second embodiment may acquire the first identification unique to the data management device 5001 from the identification management device 3002 according to the variation 1 of the first embodiment. This allows the data management device 5001 to store the electronic data without redundancy and omission of electronic data even if the plurality of data management devices 5001 is included in the data management system.

Moreover, in the variation 1 according to the first embodiment, the first identification is the information unique to the data management device. However, the first identification may not necessarily be such information. For example, the first identification may be information unique to a user operating the data management device. In this case, the data management device may acquire user information for identifying a user from the user via an input unit such as a keyboard, and read, from the identification storage unit, first identification corresponding to the acquired user information. This allows the data management device to store electronic data for each user, without redundancy and omission of electronic data.

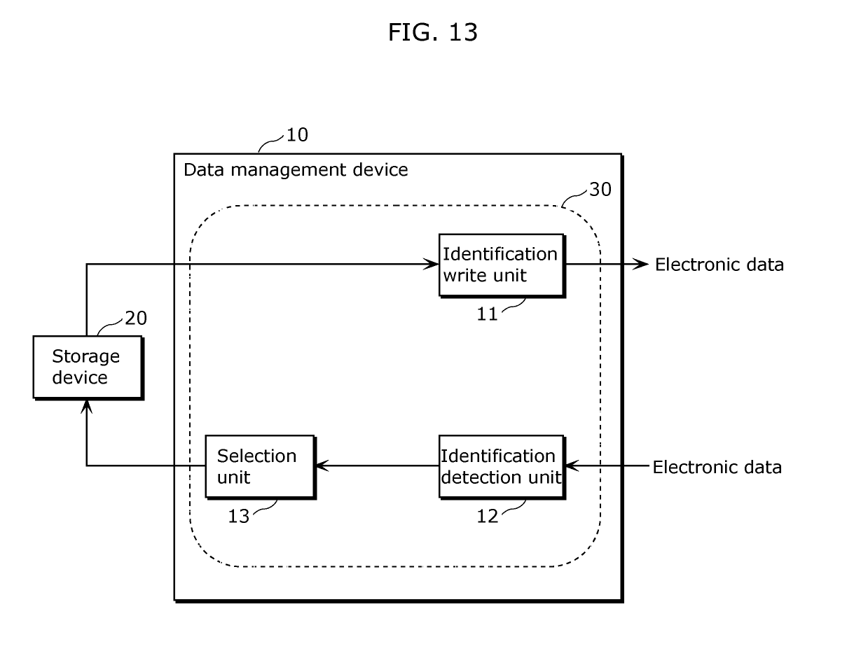

Moreover, in the embodiments described above, the data management device includes the components shown in FIG. 1. However, the data management device may not necessarily include all the components shown in FIG. 1 and so on. For example, the data management device may, as shown in FIG. 13, include a part of the components shown in FIG. 1.

FIG. 13 is a block diagram showing another configuration of the data management device according to the first embodiment or the second embodiment of the present invention. In FIG. 13, a data management device 10 includes an identification write unit 11, an identification detection unit 12, and a selection unit 13. In this case, the data management device 10 reads an image file from a storage device 20 connected with the data management device 10, and records the image file into the storage device 20.

Even if the configuration of the data management device 10 is as described in FIG. 13, the identification write unit 11 can write the identification into the image file. Thus, processing load increase in the data processing device can be reduced. Moreover, when the identification detection unit 12 determines that the first identification and the second identification detected from the image file inputted from the data processing device do not match, the selection unit 13 records the electronic data into the storage device and thereby the data management device 10 can store the image data without redundancy and omission of electronic data.

Moreover, the data management device may be implemented by a computer which includes a CPU (Central Processing Unit), a ROM (Read Only Memory), a RAM (Random Access Memory), a hard disk, and so on.

Moreover, part or the whole of the components included in the data management device according to the above embodiments may be configured with one system LSI (Large Scale Integration). For example, as shown in FIG. 13, the data management device 10 may be implemented by a system LSI 30 having the identification write unit 11, the identification detection unit 12, and the selection unit 13.

The system LSI 30 is a super multi-function LSI manufactured by integrating a plurality of components on one chip, and is, specifically, a computer system which includes a microprocessor, ROM, RAM, or the like. The computer program is stored in the RAM. The system LSI achieves its functionality by the microprocessor operating in accordance with the computer program.

Moreover, here, the term system LSI is used. However, IC, LSI, super LSI, ultra LSI may be used depending on the difference in degree of integration. Moreover, the circuit integration is not limited to the LSI and may be implemented as a dedicated circuit or a general-purpose processor. An FPGA (Field Programmable Gate Array) which is programmable after manufacturing the LSI, or a reconfigurable processor in which connection or settings of circuit cells in LSI is reconfigurable, may be used.

Furthermore, if circuit integration technology emerges replacing the LSI due to advance in semiconductor technology or other technology derived therefrom, the functional blocks may, of course, be integrated using the technology. Application of biotechnology is possible.

Moreover, the present invention can be implemented not only as the data management device that includes such characteristic processing units but also as a data management method having the characteristic processing units included in the data management device as steps. Alternatively, the present invention can be implemented as a computer program for causing a computer to execute the characteristic steps included in the data management method. In addition, such a computer program can, of course, be distributed by being stored in a computer-readable storage medium such as a CD-ROM (Compact Disc Read Only Memory) and via a communication network such as the Internet.

### INDUSTRIAL APPLICABILITY

The present invention is useful as data management devices which centrally store electronic data acquired from data processing devices to provide efficiency in managing two-dimensional information, in particular, image data as an example.

### REFERENCE SIGNS LIST

10, 1001, 4001, 5001, 8001 Data management device
11, 103, 503 Identification write unit
12, 111, 511 Identification detection unit
13, 112 Selection unit
20 Storage device
30 System LSI
101 Main storage unit
102 Identification storage unit
104 First output I/F unit
105 Second input I/F unit
106 Temporary storage unit
107 Second output I/F unit
108 Data generation unit
110 First input I/F unit
413 Device determination unit
414 Identification write control unit
509 Process/edit unit
813 Identification removal unit
1002, 5002 Data processing device
3002 Identification management device
3003 Identification management unit

1. A data management device for centrally storing electronic data acquired from a data processing device, the data management device comprising:
an identification write unit configured to write first identification indicating that the electronic data is saved in a storage device into the electronic data saved in the storage device, and output the electronic data having the written first identification to the data processing device;
an identification detection unit configured to detect second identification written in electronic data inputted from the data processing device, and determine whether the first identification and the second identification match; and
a selection unit configured to record, into the storage device, the electronic data inputted from the data processing device when it is determined that the first identification and the second identification do not match or when the second identification is not detected,
wherein the electronic data includes content data, and
the identification write unit is configured to write the first identification to the electronic data in a manner that the first identification is altered when the content data is modified, in accordance of an extent of modification of the content data.

2. The data management device according to claim 1,
wherein the identification detection unit is configured to determine whether the first identification and the second identification match, based on a similarity indicative of a degree of similarity between the first identification and the second identification.

3. The data a management device according to claim 2,
wherein the identification write unit is configured to write, as the first identification, data indicative of one of predetermined analog quantity and a predetermined multi-level, and
the identification detection unit is configured to detect, as the second identification, data indicative of one of analog quantity and a multi-level and, based on a similarity between the one of the analog quantity and the multi-level which is indicated by the detected data and the one of the predetermined analog quantity and the predetermined multi-level, determine whether the first identification and the second identification match.

4. The data management device according to claim 2,
wherein the identification write unit is configured to write, as the first identification, predetermined multi-dimensional array of data, and
the identification detection unit is configured to detect multi-dimensional array of data as the second identification, and based on a similarity between the detected multi-dimensional array of data and the predetermined multi-dimensional array of data, determine whether the first identification and the second identification match.

5. The data management device according to claim 2,
wherein the identification write unit is configured to write the first identification to the electronic data by embedding the first identification as a digital watermark into the electronic data, and
the identification detection unit is configured to detect the second identification by detecting a digital watermark embedded in the electronic data inputted from the data processing device.

6. (canceled)

7. The data management device according to claim 2,
wherein the identification write unit is configured to write the first identification to a region in which the content data is stored in the electronic data, and
the identification detection unit is configured to detect the second identification from the region in which the content data is stored in the electronic data.

8. The data management device according to claim 7,
wherein the identification write unit is configured to write the first identification to a substantially entirety of the region in which the content data is stored in the electronic data.

9. The data management device according to claim 7,
wherein the identification write unit is configured to write the first identification to a portion of the region in which the content data is stored in the electronic data.

10. The data management device according to claim 9,
wherein the identification write unit is configured to write the first identification to a portion to be read initially of the region in which the content data is stored in the electronic data.

11. The data management device according to claim 2,
wherein the identification detection unit is configured to calculate a correlation value between the first identification and the second identification, as the similarity.

12. The data management device according to claim 11,
wherein the identification detection unit is configured to determine that the first identification and the second identification match if the correlation value is greater than or equal to a predetermined reference value, and determine that the first identification and the second identification do not match if the correlation value is smaller than the predetermined reference value.

13. The data management device according to claim 1,
wherein the identification write unit is configured to write a predetermined code sequence as the first identification in the electronic data, and
the identification detection unit is configured to detect a code sequence as the second identification, and determine whether the detected code sequence and the predetermined code sequence match, to determine whether the first identification and the second identification match.

14. The data management device according to claim 1,
wherein the electronic data includes content data and related data indicative of information on the electronic data,
the identification write unit is configured to write the first identification to a region in which the related data is stored in the electronic data, and
the identification detection unit is configured to detect the second identification from the region in which the related data is stored in the electronic data.

15. The data management device according to claim 1, further comprising
an identification removal unit configured to remove the second identification from the electronic data inputted from the data processing device if it is determined that the first identification and the second identification do not match,
wherein the selection unit is configured to record into the storage device the electronic data from which the second identification has been removed by the identification removal unit.

16. The data management device according to claim 1,
wherein the first identification is information unique to the data management device.

17. The data management device according to claim 1, further comprising
an identification write control unit configured to control whether to cause the identification write unit to write the first identification to the electronic data, in accordance with functionality of the data processing device.

18. The data management device according to claim 1
wherein the data management device is arranged as an integrated circuit.

19. A data management method for centrally storing electronic data acquired from a data processing device, the data management method comprising:
writing first identification indicating that the electronic data is saved in a storage device into the electronic data saved in the storage device, and outputting the electronic data having the written first identification to the data processing device;
detecting second identification written in electronic data inputted from the data processing device, and determining whether the first identification and the second identification match; and
recording, into the storage device, the electronic data inputted from the data processing device when it is determined that the first identification and the second identification do not match or when the second identification is not detected,
wherein the electronic data includes content data, and
when writing first identification, writing the first identification to the electronic data in a manner that the first identification is altered when the content data is modified, in accordance of an extent of modification of the content data.

20. A non-transitory computer-readable recording medium having stored therein a program for causing a computer to execute the data management method according to claim 19.
